(19) United States
(12) Patent Application Publication
(10) Pub. No.: US 2019/0176535 A1
(43) Pub. Date: Jun. 13, 2019

(54) PNEUMATIC TIRE

(71) Applicant: Toyo Tire & Rubber Co., Ltd., Itami-shi (JP)

(72) Inventor: Toshikazu Yasunaga, Itami-shi (JP)

(73) Assignee: Toyo Tire & Rubber Co., Ltd., Itami-shi (JP)

(21) Appl. No.: 16/210,224

(22) Filed: Dec. 5, 2018

(30) Foreign Application Priority Data
Dec. 13, 2017 (JP) 2017-238855

(51) Int. Cl. B60C 11/12; B60C 11/03

(52) U.S. Cl. CPC B60C 11/125; B60C 11/0309; B60C 11/032; B60C 2011/1213; B60C 2011/0358; B60C 2011/0381; B60C 2011/0346

(57) ABSTRACT

In a pneumatic tire, an annular sipe (80) is provided in a land portion (36), and the annular sipe (80) is constituted by a plurality of independent small sipes (81) extending in a circumferential direction of the annular sipe (80).

### CROSS-REFERENCE TO RELATED APPLICATIONS

This application is based on Japanese Patent Application No. 2017-238855 (filed on Dec. 13, 2017) and claims priority from Japanese Patent Application No. 2017-238855. The present disclosure incorporates entire contents of Japanese Patent Application No. 2017-238855.

### TECHNICAL FIELD

The present disclosure relates to a pneumatic tire.

### BACKGROUND ART

For example, as disclosed in Patent Documents 1 to 3, it has been known to provide a narrow groove called a sipe in a tread of a pneumatic tire. Since an edge effect occurs in a direction orthogonal to an extending direction of the sipe, a pneumatic tire having a sipe is suitable for traveling on snow.

Patent Document 1: JP-A-2015-166243

Patent Document 2: JP-A-2014-172600

Patent Document 3: Japanese Patent No. 5814985

### DISCLOSURE OF THE INVENTION

### Problem that the Invention is to Solve

However, in a sipe in the related art, there is a problem that an edge effect does not occur in an extending direction of the sipe.

Therefore, the present disclosure is to provide a pneumatic tire having a sipe that causes an edge effect in all directions.

### Means for Solving the Problem

In a pneumatic tire of an embodiment, an annular sipe is provided in a land portion, and the annular sipe is constituted by a plurality of independent small sipes extending in a circumferential direction of the annular sipe.

### Advantage of the Invention

In the pneumatic tire of the embodiment, an edge effect occurs in all directions by the annular sipe.

### BRIEF DESCRIPTION OF THE DRAWINGS

FIG. 1 A cross-sectional view in the width direction of a pneumatic tire of an embodiment.

FIG. 2 A tread pattern of the pneumatic tire of the embodiment.

FIG. 3 A tread pattern of the pneumatic tire of a modification.

FIG. 4 An enlarged view of an annular sipe.

FIG. 5 A cross-sectional view in a width direction of a small sipe.

### BEST MODE FOR CARRYING OUT THE INVENTION

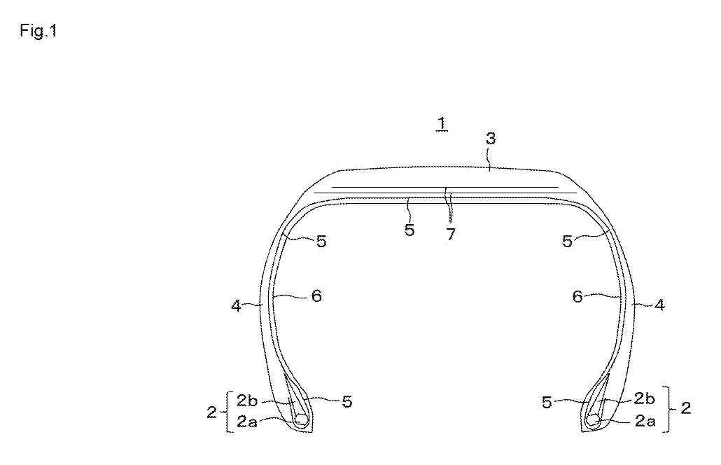

As illustrated in FIG. 1, a bead portion 2 is provided on both sides in a tire width direction of a pneumatic tire 1. The bead portion 2 is constituted by a bead core 2a made of a steel wire wound in a circular shape and a bead filler 2b made of rubber and provided on a radial outer side of the bead core 2a. A carcass ply 5 is laid across the bead portion 2 on both sides in the tire width direction. The carcass ply 5 is a sheet type member in which a plurality of ply cords arranged in a direction orthogonal to a circumferential direction of the tire are covered with rubber. The carcass ply 5 forms a frame shape of the pneumatic tire 1 between the bead portions 2 on both sides of the tire width direction, and surrounds the bead portions 2 by folding back from inside to outside in the tire width direction around the bead portions 2. A sheet type inner liner 6 made of rubber having low air permeability is adhered to the inside of the carcass ply 5.

One or a plurality of belts 7 are provided on the tire radial outer side of the carcass ply 5. The belt 7 is a member made by covering a plurality of steel-based cords with rubber. A tread rubber 3 having a grounding surface with a road surface (hereinafter, referred to as a “grounding surface”) is provided on the tire radial outer side of the belt 7. Further, a side wall rubber 4 is provided on both sides in the tire width direction of the carcass ply 5. In addition to these members, according to functional requirements of the pneumatic tire 1, members, for example, a belt lower pad or a chafer are provided.

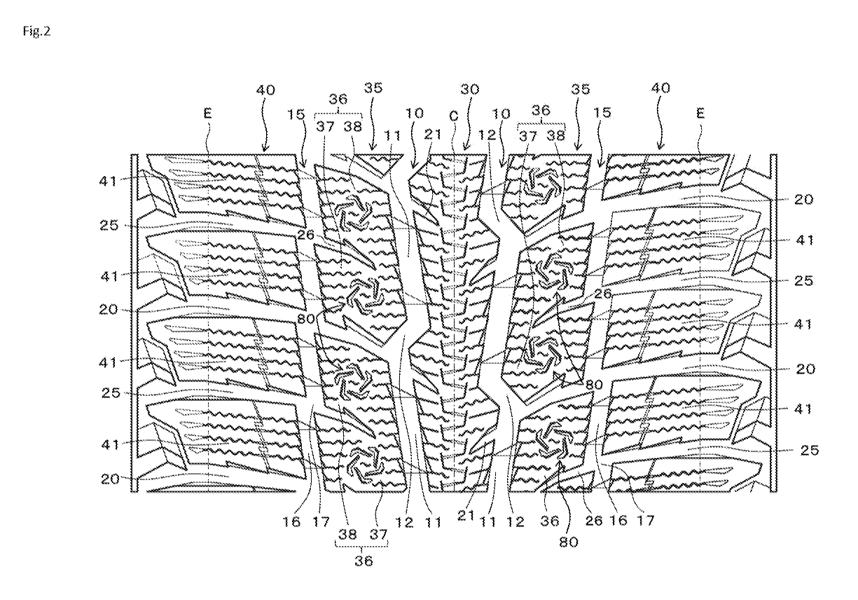

A tread pattern illustrated in FIG. 2 is formed on a surface of the tread rubber 3. In FIG. 2, the vertical direction is the circumferential direction of the tire, and the lateral direction is the tire width direction. Further, in FIG. 2, a lower side is grounded first during rolling of the tire (that is, when the vehicle is traveling).

In this tread pattern, as a main groove that extends in the circumferential direction of the tire and has a wide width, a total of four main grooves, that is, two center main grooves 10 on a tire equator C side (center side in the tire width direction) and two shoulder main grooves 15 on a tire grounding end E side (an outer side in the tire width direction) are formed. Then, a center land portion 30 between the two center main grooves 10, a mediate land portion 35 between the center main groove 10 and the shoulder main groove 15, and a shoulder land portion 40 between the shoulder main groove 15 and the tire grounding end E are provided.

Here, the land portion is a portion formed by being partitioned by grooves. Further, the tire grounding end E is an end portion of the grounding surface in the tire width direction in a loaded state. The loaded state is a state where the pneumatic tire is rim-assembled into a normal rim to be a normal inner pressure and loaded by a normal load. Here, the normal rim is a standard rim defined by standards such as JATMA, TRA, and ETRTO. Further, the normal load is a maximum load defined in the above standards. Further, the normal inner pressure is an inner pressure corresponding to the maximum load.

The center main groove 10 includes long first groove portions 11 that extend obliquely with respect to the circumferential direction of the tire, and short second groove portions 12 that are inclined with respect to the circumferential direction of the tire and extend in a direction different from that of the first groove portion 11. Then, the first groove portion 11 and the second groove portion 12 are arranged alternately, and thus, the center main groove 10 is formed in a zigzag shape.

The shoulder main groove 15 includes long first groove portions 16 that extend obliquely with respect to the circumferential direction of the tire, and short second groove portions 17 that are inclined with respect to the circumferential direction of the tire and extend in a direction different from that of the first groove portion 16. Then, the first groove portion 16 and the second groove portion 17 are arranged alternately, and thus, the shoulder main groove 15 has a zigzag shape.

Further, as lateral grooves that extend in the tire width direction, first lateral grooves 20 and second lateral grooves 25 are formed. The first lateral grooves 20 and second lateral grooves 25 are alternately formed in the circumferential direction of the tire. The first lateral groove 20 and the second lateral groove 25 extend obliquely such that the tire grounding end E side is grounded later during rolling of the tire.

The first lateral groove 20 traverses the shoulder land portion 40 and the mediate land portion 35, and extends to the center land portion 30 and is closed in the center land portion 30. Therefore, a notch 21 that is a part of the first lateral grooves 20 is formed in the center land portion 30.

Further, the second lateral groove 25 traverses the shoulder land portion 40, and extends to the mediate land portion 35 and is closed in the mediate land portion 35. Therefore, a notch 26 that is a part of the second lateral grooves 25 is formed in the mediate land portion 35.

The second groove portion 17 of the shoulder main groove 15 overlaps with the first lateral groove 20 and the second lateral groove 25.

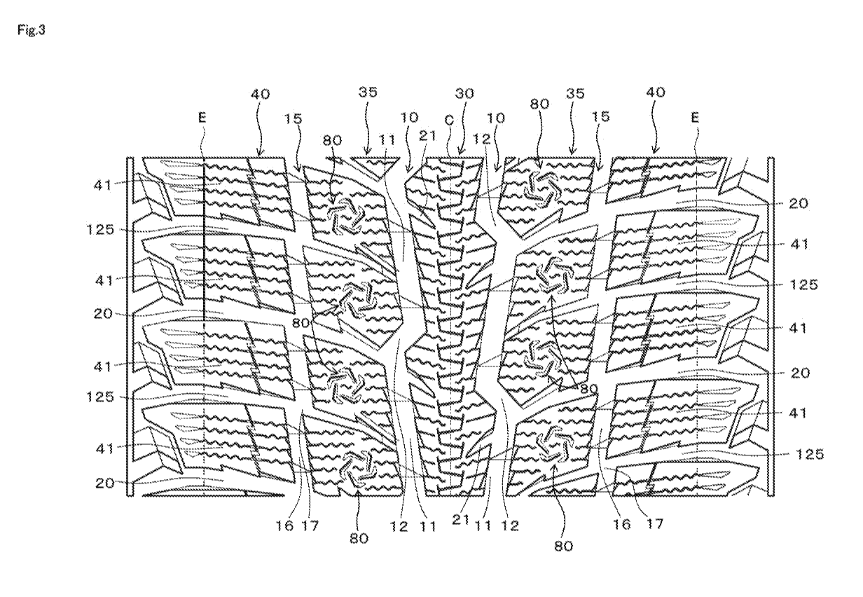

As a modification, as illustrated in FIG. 3, a second lateral groove 125 which is a substitute for the second lateral groove 25 may traverse the shoulder land portion 40 and the mediate land portion 35, and then end in the center main groove 10 while being opened. The tread pattern in FIG. 2 is used for, for example, a high-performance tire, and a tread pattern in FIG. 3 is used for, for example, a tire for a sports utility vehicle (SUV). Hereinafter, the tread pattern in FIG. 2 will be described as an example.

With the configuration of the groove as described above, the center land portion 30 between the two center main grooves 10 is configured as a rib extending in the circumferential direction of the tire without being divided by lateral grooves. Further, the mediate land portion 35 is divided by the first lateral groove 20, and thus, is a row of a plurality of mediate blocks 36 arranged in the circumferential direction of the tire. In the mediate block 36, a portion to be grounded prior to the notch 26 is referred to as “a stepped side block portion 37,” and a portion to be grounded later than the notch 26 is referred to as “a kick-out side block portion 38.” Further, the shoulder land portion 40 is divided by the first lateral groove 20 and the second lateral groove 25, and thus, is a row of a plurality of shoulder blocks 41 arranged in the circumferential direction of the tire.

An annular sipe 80 is formed one by one on each of the stepped side block portion 37 and the kick-out side block portion 38 of the mediate block 36. The annular sipe 80 on the stepped side block portion 37 is closer to the tire equator C than the annular sipe 80 on the kick-out side block portion 38. Then, since the annular sipe 80 is formed on the stepped side block portion 37 and the kick-out side block portion 38 of each of the mediate blocks 36 arranged in the circumferential direction of the tire, the annular sipes 80 are arranged in a zigzag manner in the circumferential direction of the tire.

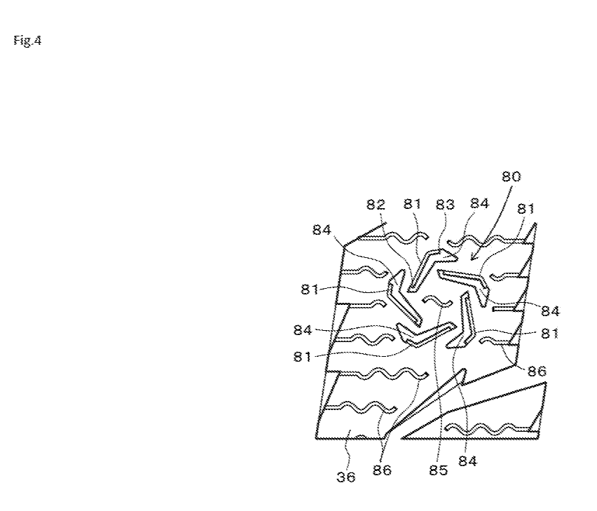

As illustrated in FIG. 4, the annular sipe 80 is formed by annularly arranging a plurality of (e.g., five as illustrated in the drawing) independent small sipes 81. A small sipe 81 is a narrow groove having a narrow width of, for example, 0.4 to 0.6 mm, which is so small as to be occluded in the loaded state when a dimple 84 to be described later disappears due to wear. The small sipe 81 extends in a circumferential direction of the annular sipe 80. Further, the small sipe 81 is bent toward the inner side of the annular sipe 80 (in other words, so as to extend along a circumference of the annular sipe 80). Further, one end of the small sipe 81 is closer to a center of the annular sipe 80 than the other end thereof. The end portion of the small sipe 81 which is closer to the center of the annular sipe 80 is referred to as a “center side end portion 82”, and the end portion on the other side is referred to as an “outer side end portion 82.” A relationship between a length from the bent portion of the small sipe 81 to the center side end portion 82 and a length from the bent portion to the outer side end portion 83 is not limited, but in the case of the illustrated embodiment, the length from the bent portion to the center side end portion 82 is longer.

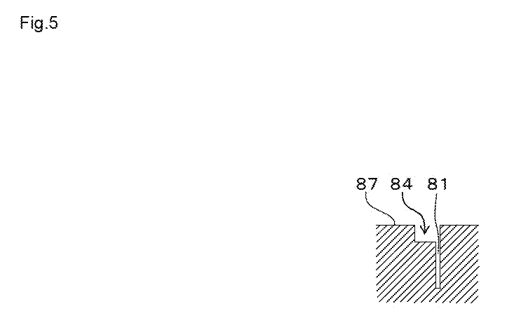

The dimple 84 is formed along the small sipe 81 on the inner side of the bent portion of the small sipe 81. As illustrated in FIG. 5, the dimple 84 is a recessed portion with respect to a grounding surface 87. A depth of the dimple 84 is shallower than that of the adjacent small sipe 81, and for example, is 40% or less of a depth of the small sipe 81.

Further, a width of the dimple 84 (that is, a length of a direction orthogonal to the extending direction of the small sipe 81) is narrow on the center side end portion 82 of the small sipe 81 and is widened toward the outer side end portion 83 of the small sipe 81. Therefore, the width of the dimple 84 is narrow on the inner side of the annular sipe 80 and is widened toward the outer side.

Sipes other than the annular sipe 80 are formed in the mediate block 36. For example, a center sipe 85 independent from the small sipe 81 that constitutes the annular sipe 80 is provided on the inner side of the annular sipe 80. The center sipe 85 is, for example, wavy in a plan view. Further, for example, on the outer radial side of the annular sipe 80, a plurality of width direction sipes 86 extending in the tire width direction are formed.

Since the annular sipe 80 is formed in the embodiment as described above, an edge effect occurs in all directions. Here, since the annular sipe 80 is constituted by the plurality of independent small sipes 81, as compared with a case where one circular sipe is formed, the rigidity in the vicinity of the annular sipe 80 hardly decreases.

Further, since the center sipe 85 is provided on the inner side of the annular sipe 80, the rigidity on the inner side of the annular sipe 80 decreases and the rigidity of the entire vicinity of the annular sipe 80 becomes uniform.

Further, since dimple 84 is formed along the small sipe 81, rubber in the vicinity of the small sipe 81 is easy to move, and further a contour of the recessed portion (that is, an edge) obtained by adding the small sipe 81 and the dimple 84 is long. Therefore, the edge effect is exerted more remarkably.

Further, since the small sipe 81 is bent toward the inner side of the annular sipe 80, as compared with a case where it is not bent, the size of the annular sipe 80 is not changed and the small sipe 81 is long. Therefore, the edge effect is exerted more remarkably.

Here, the rigidity of the inner side of the bent portion may be decreased when simply the small sipe 81 is bent, but, since the dimple 84 is formed on the inner side of the bent portion, a portion with a low rigidity is removed. Therefore, the rigidity of the entire vicinity of the annular sipe 80 becomes uniform.

Further, since the width of the dimple 84 is widened from the center side end portion 82 of the small sipe 81 toward the outer side end portion 83 thereof, snow or water that has entered into the annular sipe 80 is likely discharged to the outer radial side of the annular sipe 80.

Further, since the annular sipes 80 are arranged in a zigzag manner, the edge effect is exerted over a wide range in the tire width direction.

The above embodiments are examples, and the scope of the present disclosure is not limited thereto. Various modifications may be made to the above embodiments within the scope without escaping from the purpose of the present disclosure.

In the above embodiment, the annular sipe 80 is formed in the mediate land portion 35, but the annular sipe 80 may be formed in at least one of the center land portion 30 or the shoulder land portion 40, instead of the mediate land portion 35, or with the mediate land portion 35. Further, the tread pattern is not limited to those having the center land portion 30, the mediate land portion 35, and the shoulder land portion 40.

### Description of Reference Numerals and Signs

C . . . tire equator, E . . . tire grounding end, 1 . . . pneumatic tire, 2 . . . bead portion, 2a . . . bead core, 2b . . . bead filler, 3 . . . tread rubber, 4 . . . side wall rubber, 5 . . . carcass ply, 6 . . . inner liner, 7 . . . belt, 10 . . . center main groove, 11 . . . first groove portion, 12 . . . second groove portion, 15 . . . shoulder main groove, 16 . . . first groove portion, 17 . . . second groove portion, 20 . . . first lateral groove, 21 . . . notch, 25 . . . second lateral groove, 26 . . . notch, 30 . . . center land portion, 35 . . . mediate land portion, 36 . . . mediate block, 37 . . . stepped side block portion, 38 . . . kick-out side block portion, 40 . . . shoulder land portion, 41 . . . shoulder block, 80 . . . annular sipe, 81 . . . small sipe, 82 . . . center side end portion, 83 . . . outer side end portion, 84 . . . dimple, 85 . . . center sipe, 86 . . . width direction sipe, 87 . . . grounding surface, 125 . . . second lateral groove

1. A pneumatic tire, wherein an annular sipe is provided in a land portion, and the annular sipe is constituted by a plurality of independent small sipes extending in a circumferential direction of the annular sipe.

2. The pneumatic tire according to claim 1, wherein another sipe is provided on inner side of the annular sipe.

3. The pneumatic tire according to claim 1, wherein a dimple is formed along each of the small sipes.

4. The pneumatic tire according to claim 1, wherein the small sipe is bent toward the inner side of the annular sipe.

5. The pneumatic tire according to claim 3, wherein the small sipe is bent toward the inner side of the annular sipe, and the dimple is formed on an inner side of a bent portion.

6. The pneumatic tire according to claim 3, wherein one end of the small sipe is closer to a center of the annular sipe than the other end of the small sipe, and a width of the dimple is widened from the one end toward the other end.

7. The pneumatic tire according to claim 1, wherein the plurality of annular sipes are arranged in a zigzag manner in a circumferential direction of the pneumatic tire.
